(19) United States
(12) Patent Application Publication
(10) Pub. No.: US 2020/0122148 A1
(43) Pub. Date: Apr. 23, 2020

(54) PRECISION CUVETTE HOLDERS AND SUPPORTS FOR OPTICAL CHARACTERIZATION AND MEASUREMENTS

(71) Applicant: Saudi Arabian Oil Company, Dhahran (SA)

(72) Inventors: Vincent Cunningham, Ferbane (IE); Ezzat Hegazi, Ontario (CA)

(73) Assignee: Saudi Arabian Oil Company, Dhahran (SA)

(21) Appl. No.: 16/167,236

(22) Filed: Oct. 22, 2018

(51) Int. Cl. B01L 9/06; G01N 21/03

(52) U.S. Cl. CPC B01L 9/06; G01N 21/0303; B01L 2300/0627; G01N 2201/061; B01L 2300/0858; G01N 2021/0367; B01L 2300/0809

(57) ABSTRACT

This disclosure describes a cuvette holder. The cuvette holder includes a base and a body extending from the base. The body includes a first wall, and the body defining an interior cavity. A first aperture extends through the first wall of the body. The first aperture can have a width measured parallel to the base of between 12 and 12.6 millimeters.

### TECHNICAL FIELD

This specification relates to a structure for holding a cuvette.

### BACKGROUND

Imaging systems often include a cuvette, a liquid sample held within the cuvette, a cuvette holder, a light source, and an optical sensor. During imaging, the cuvette holds the liquid sample and the cuvette holder holds the cuvette. The light source shines an incident light beam through the cuvette and cuvette holder. The incident beam interacts with particles in the liquid sample and a reflected beam is generated. The sensor measures the reflected beam to generate imaging data.

### SUMMARY

This disclosure describes cuvette holders, structures for holding a cuvette (for example during optical characterization and imaging), which can reduce noise within imaging data by reducing movement of the cuvette within the cuvette holder and reducing movement of the cuvette on a benchtop. The cuvette holders have fasteners that secure the cuvette holders to other commonly used and commercially available opto-mechanical parts and platforms. The fasteners may reduce noise in the measurements by maintaining alignment and reducing small or large movements of the cuvette holder.

The cuvette holders can also be used for attenuation measurements in which the light completely traverses the cuvette and cuvette holder and the remaining light is collected using the optical detector. The attenuation can be used to characterize the samples. The cuvette holders can also be used for fluorescence measurements where the optical sample interaction produces light used to characterize the sample upon excitation and relaxation at the atomic level of the sample.

The cuvette holders can also be used in hybrid and non-optical techniques with other sources of electromagnetic radiation with an associated detector. For example, the cuvette holders can be used in photoacoustics (commonly referred to as optoacoustics). In these techniques, the incident energy is optical energy and there is a conversion from optical to mechanical waves (e.g., ultrasonic waves) through thermal expansion of the liquid in a stress confined medium (i.e., localized heating within the sample). The mechanical waves are measured using a sensor such as, for example, an ultrasonic probe.

Some cuvette holders include a base and a body extending from the base. The body includes a first wall and the body defines an interior cavity. A first aperture extends through the first wall of the body. The first aperture has a width measured parallel to the base of between 12 and 12.6 millimeters (mm).

Some cuvette holders include a base and a body extending from the base. The body includes a first wall and a second wall adjacent the first wall. The body defines an interior cavity. The first wall defines a first aperture extending through the first wall. The first aperture has a width measured parallel to the base of between 12 and 12.6 mm. The second wall defines a second aperture extending through second wall. The second aperture has a width measured parallel to the base of between 12 and 12.6 mm. The first aperture and the second aperture are connected and form a single, large aperture spanning the first and the second walls.

Some cuvette holders include a base and four walls extending from the base and defining an interior cavity. Each of the four walls define an aperture that extends through the wall. Each of the apertures has a width measured parallel to the base of between 12 and 12.6 mm. Each of the apertures has the same dimensions. The cuvette holder also includes a plurality of plates detachably mountable to the body. Each of the plates is sized to cover one of the apertures.

Embodiments of these cuvette holders can include one or more of the following features.

In some embodiments, a second aperture extends through a second wall of the body, the second aperture having a width measured parallel to the base of between 12 and 12.6 mm, the second wall of the body adjacent the first wall of the body. In some cases, the first aperture and the second aperture are connected and form a single, large aperture spanning the first and the second walls.

In some cases, a third aperture extends through a third wall of the body opposite the first wall of the body. A fourth aperture may also extend through a fourth wall of the body opposite the second wall of the body. In some cases, the first, second, third, and fourth apertures have the same dimensions. In some cases, the cuvette holder includes a plurality of plates detachably mountable to an outer surface of the body, each of the plates sized to cover one of the first, second, third, and fourth apertures. Some plates are free of apertures. Some plates define a slit aperture. Some plates define a pinhole aperture.

In some embodiments, the first wall has a thickness between 0.8 and 1.2 mm.

In some embodiments, the base includes ferromagnetic material. In some cases, the base is at least 10% by weight ferromagnetic material (for example, more than 10%, more than 15%, more than 25%, more than 35% or more than 50% by weight ferromagnetic material).

In some embodiments, the base includes flanges that extend laterally beyond the body, the flanges defining apertures sized to receive fasteners.

In some embodiments, wherein the interior cavity has a rectangular cross-section parallel to the base with a length between 11.5 and 12.6 mm. In some cases, the rectangular cross-section has a width between 12.5 and 12.6 mm. In some cases, the rectangular cross-section has a width between 3.5 and 3.6 mm. In some cases, the rectangular cross-section has a width between 4.5 and 4.6 mm.

In some embodiments, the body includes a second wall opposite the first wall. The second wall defines a pinhole aperture extending through the second wall.

In some embodiments, the first wall has a thickness between 0.1 and 1.2 mm.

The described cuvette holders are close-fitting structures that receive a cuvette. These cuvette holders can increase stable and repeatable measurements of optical based phenomena resulting from liquid samples contained in cuvettes. Some of these cuvette holders provide controlled access to the liquid contents of a cuvette via a series of slits or openings. These cuvette holders are can be used for fluorescence measurements and optical attenuation measurements based on scattering and absorption. Some cuvette holders can also be used for reflection and transmission based measurements.

Some of these cuvette holders have fasteners that can secure these cuvette holders to other commonly used and commercially available opto-mechanical parts and platforms. The fasteners may reduce noise in the measurements by maintaining alignment and reducing small or large movement of the cuvette holder.

The cuvette holders can be adapted to a variety of cuvette sizes (for example, 1-mm, 2-mm, and 10-mm optical path cuvettes. The cuvette holders can be made of a wide selection of materials, for example plastics, metals and ferromagnetic materials for magnetic based support. The cuvette holders can be used for cuvettes of all material types, for example, quartz, optical glass, or plastic cuvettes.

The details of one or more embodiments of these systems and methods are set forth in the accompanying drawings and the description. Other features, objects, and advantages will be apparent from the description and drawings, and from the claims.

### BRIEF DESCRIPTION OF THE DRAWINGS

FIGS. 1A and 1B are perspective views of a cuvette holder with and without the cuvette.

FIG. 1C is a perspective view of the cuvette shown in FIG. 1A.

FIG. 2 is a perspective view of a cuvette holder.

FIG. 3 is a perspective view of a cuvette holder.

FIG. 4 is a perspective view of a cuvette holder.

FIG. 5 is a perspective view of a cuvette holder that has an aperture in one wall.

FIGS. 6A and 6B are perspective views of a cuvette holder that has apertures in all four walls, with and without a cuvette.

FIGS. 7A and 7B are, respectively, a perspective view and side view of a plate with an aperture that can be detachably mounted on the cuvette holder shown in FIGS. 6A and 6B.

FIG. 8 is a perspective view of a plate without an aperture that can be detachably mounted on the cuvette holder shown in FIGS. 6A and 6B.

FIG. 9 is a perspective view of a plate that has a slit aperture that can be detachably mounted on the cuvette holder shown in FIGS. 6A and 6B.

FIG. 10 is a perspective view of a plate that has a pinhole aperture that can be detachably mounted on the cuvette holder shown in FIGS. 6A and 6B.

Like reference numbers and designations in the various drawings indicate like elements.

### DETAILED DESCRIPTION

Measurement of optical phenomena such as, fluorescent imaging and optical attenuation, can be performed on liquid samples in a cuvette. During imaging, the cuvette holding the sample can be placed in a structure known as a cuvette holder. This specification describes cuvette holders that closely receive a cuvette so that the cuvette remains fixed in position during imaging. This can reduce noise within the imaging data or intensity measurements such as, for example, fluorescence and attenuation measurements. The cuvette holder includes four walls with at least one aperture extending through a wall. Some cuvette holders have additional apertures to allow a variety of imaging or intensity measurement techniques. For example, the cuvette holder may have two adjacent and connected apertures that enable 90 degree optical imaging or fluorescence intensity measurement in which light is directed into one aperture. This configuration can be used for measuring the scattered light at 90 degrees or the fluorescence at 90 degrees after passing through the liquid sample. In this approach, a sensor collects emission data from the second aperture, at a 90-degree angle from the light source. This cuvette holder also allows data collection at angles less than 90 degrees. Some cuvette holders have a securing feature to secure the cuvette holder to commonly used and commercially available opto-mechanical parts and platforms.

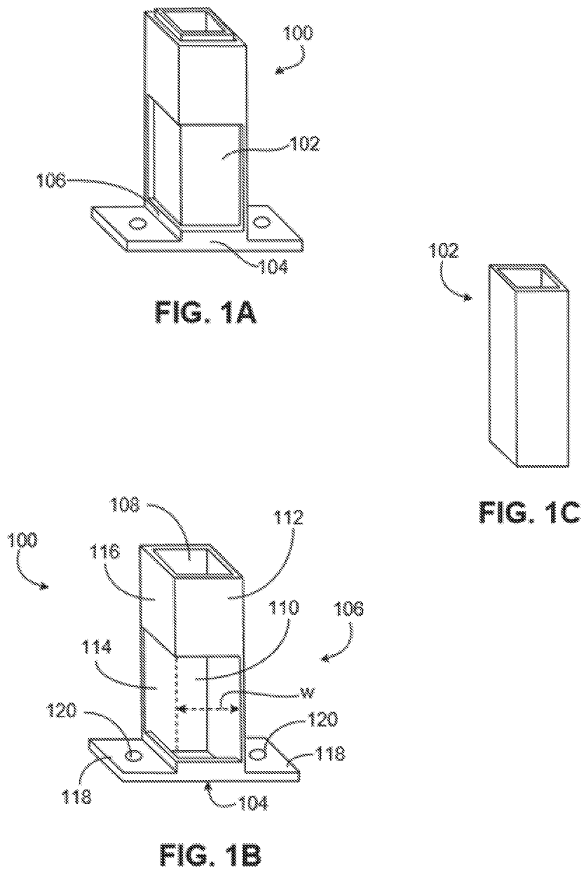

FIGS. 1A and 1B show a cuvette holder 100 holding a cuvette 102 during imaging. The cuvette holder includes a base 104 and a body 106 extending from the base 104. The body 106 has four walls that define an interior cavity 108. A first aperture 110 extends through a first wall 112 and a second aperture 114 extends through a second wall 116. In some cuvette holders, the width W of the apertures 110, 114 is between 9.5 mm and 10.1 mm. For apertures extending to an edge of the wall by which they are defined, the “width” W of the aperture indicates the distance between the edge of the aperture to the edge of the wall on the open side of the aperture. The width W of the first aperture 110 of the cuvette holder 100 is approximately 10 mm. The first and second apertures 110, 114 connect to form a single, large aperture spanning the first and the second walls 112, 116. The large aperture spanning the first and the second walls 112, 116 can be used in imaging techniques that require an acute angle or 90-degree angle between an incident beam from a light source and a reflected beam measured by a sensor. The cuvette holder 100 also includes flanges 118 that extend from the base laterally beyond the body 106. The flanges 118 can be used to secure the cuvette holder 100 to an optical bench or other custom-designed or commercially available opto-mechanical parts. The flanges 118 define apertures 120 sized to receive fasteners. For example, the apertures 120 can be threaded to receive imperial or metric screws. Alternatively, the holes may not be threaded. In both approaches, the screws are used to attach the flanges 118 to the bench. Some cuvette holders use other fasteners to secure the cuvette holder 100 to the bench such as, for example, bolts or snap fittings.

The walls of cuvette holders usually have a thickness between 0.8 and 1.2 mm. In some cuvette holders, the thickness may be between 0.1 and 1.2 mm.

The interior cavity 108 has a rectangular cross-section parallel to the base 104 sized to fit closely around a cuvette. The cross-section of the interior cavity 108 has a length l of between 12.5 and 12.6 mm and a width w of between 12.5 and 12.6 mm. This configuration is sized to receive standard 10-mm by 10-mm cuvettes. Cuvettes are defined in terms of their internal dimensions and typically have walls which add ˜2.5 mm to their external dimensions. Some cuvette holders are sized to receive shorter optical path cuvettes. For example, the cross-section of such cuvette holders can have a length l of between 12.5 and 12.6 mm and a width w of between 3.5 and 3.6 mm or a width w of between 4.5 and 4.6 mm.

FIG. 1C shows the cuvette 102. The cuvette 102 contains a substance that absorbs and/or scatters light. The cuvette comprises transparent material so that light may pass through a wall of the cuvette 102. The cuvette holder 100 is shaped to receive the cuvette 102 tightly.

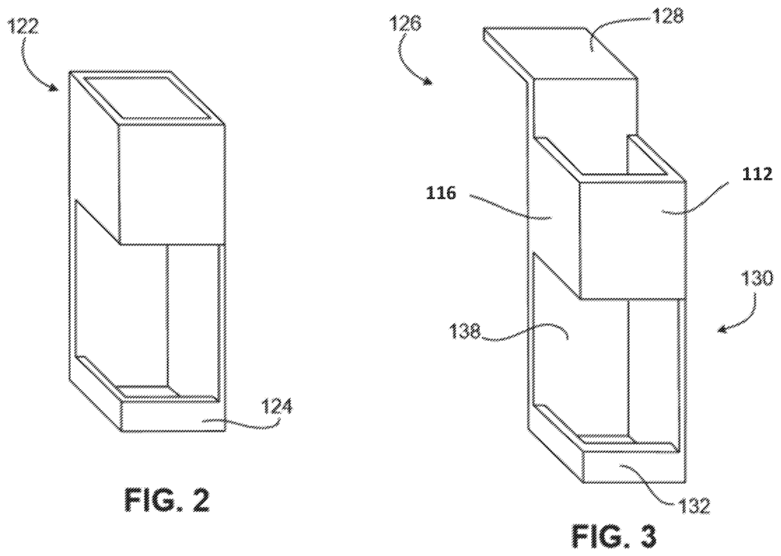

FIG. 2 shows a cuvette holder 122 for holding the cuvette 102 during imaging. The cuvette holder 122 is substantially similar to the cuvette holder 100 in FIGS. 1A and 1B but is held in position by magnetic forces. The cuvette holder 122 does not have flanges. Rather, the base 124 of the cuvette holder 122 includes ferromagnetic material. The bases 124 of cuvette holders held in position by magnetic forces are typically at least 10% by weight ferromagnetic material (for example, more than 10%, more than 15%, more than 25%, more than 35% or more than 50% by weight ferromagnetic material).

The base 124 of the cuvette holder 122 is approximately 15% by weight magnetic stainless steel. The cuvette holder 122 can be secured to a bench, or to custom-designed or commercially available opto-mechanical parts, by applying a magnetic force to the ferromagnetic material. For example, the cuvette holder 122 can be secured in place by placing a magnet on the underside of the bench and placing the cuvette holder 122 on the upper side of the bench directly above the magnet. In some cuvette holders, the ferromagnetic material may be magnetized such that the cuvette holder 122 is fixed to a metal surface by placing the cuvette holder 122 on the metal surface.

Some bases or entire cuvette holders include other ferromagnetic materials such as, for example, include steel or iron.

FIG. 3 shows a cuvette holder 126. The cuvette holder 126 is substantially similar to the cuvette holder 122 in FIG. 2. The cuvette holder 126 includes ferromagnetic material. The cuvette holder 126 also includes a flange 128 that protrudes laterally from a wall of the body 130. The cuvette holder 126 has a body 130 and a base 132. The body 130 has four walls including a first wall 112, a second wall 116, and a third wall 138, opposite the first wall 112. The flange 128 is configured to position the cuvette holder 126, for example, by hanging the cuvette holder 126 from a fixed support (not shown). In the cuvette holder 126, the flange 128 extends from the third wall 138. In some cuvette holders, the flange 128 extends from other walls of the body 130. The flange 128 is positioned on an end of the body 130 opposite the base 112. In some cuvette holders, the flange 128 extends from other sections of the originating wall such as, for example, protruding from a mid-point of the wall. The flange 128 is the same width as the third wall 138. However, the flange 128 may be wider or narrower than the wall from which the flange 128 extends.

The flanges can also be used to aid in fine positioning of the cuvette. This approach can make it is easier to move the cuvette while avoiding contact with the cuvette surface which can create smudges on the surface.

The cuvette holders 100, 122, 126 in FIGS. 1A-1C, 2, and 3 can be used in 90-degree angle imaging. The cuvette holders 100, 122, 126 can also be used in acute angle imaging.

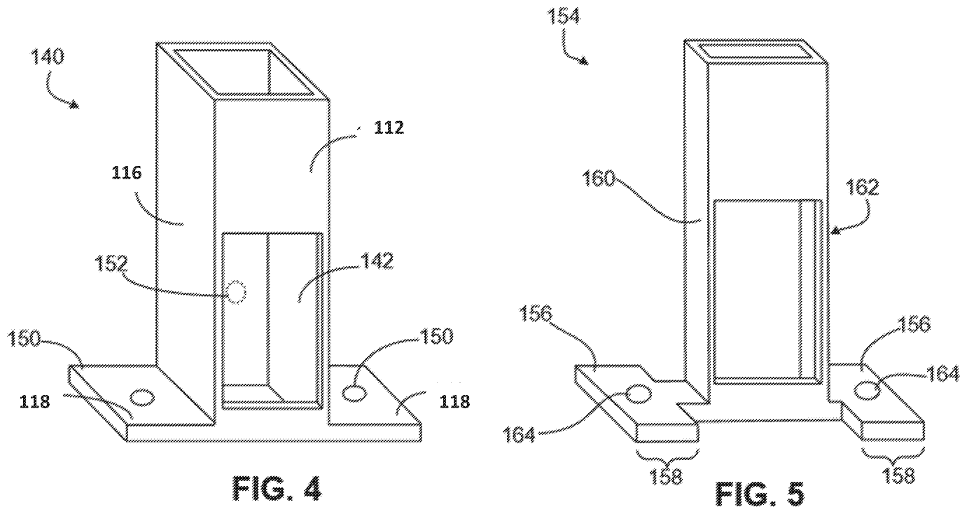

FIG. 4 shows a cuvette holder 140 that is substantially similar to cuvette holder 100 in FIG. 1A. However, cuvette holder 140 has one aperture 142 that extends through a first wall 112 and a pinhole aperture 152 extending through the third wall 116 rather than two apertures on adjacent walls that connect to form one large aperture. The pinhole aperture 152 is a small, circular opening that allows a small amount of light to pass through. Pinhole aperture can vary widely in in the sub-mm to mm size range. In general, pinhole apertures have a diameter of no less than 40 times the wavelength of the light they are intended to be used with. The pinhole aperture 152 is 0.3-0.5 mm in diameter. The pinhole configuration can be used for attenuation measurements in a scattering medium. If no pinhole were present, the light reaching the detector would be from the attenuated light and also the forward scattered light. Use of a pin-hole aperture limits the amount of forward scattered light reaching the detector and allows a more accurate measurement of the attenuated light. The cuvette holder 140 has flanges 118 that extend laterally from the body and define openings 150 sized to receive fasteners for securing the cuvette holder to a surface.

FIG. 5 shows a cuvette holder 154 that is substantially similar to cuvette holder 140 in FIG. 4. However, the cuvette holder 154 is used to hold cuvettes with short optical pathways. The cuvette holder 154 defines a cavity that is sized to receive a 10-mm by 1-mm cuvette tightly. Similar cuvette holders can be sized to receive 10-mm by 2-mm cuvettes.

The cuvette holder 154 includes flanges 156. However, flanges 156 differ from flanges 118 in FIG. 4. Flanges 156 are T-shaped. The flanges 156 include a rectangular portion 158 that is connected to the base 124 by a connector section 159. The flanges 156 also include openings 164 for securing the cuvette holder 154 to a surface. In some cuvette holders, the flanges 156 are sized so that the shortened optical path cuvette and cuvette holder 154 can easily be used in a system designed for a holder for a standard 10-mm by 10-mm cuvette. For example, the cuvette holder 154 and cuvette holder 140 have similar flange lengths and positioning of the openings 150, 164 so that the cuvette holder 154 can be used in an optical measuring system configured for the cuvette holder 140.

The cuvette holders shown in FIGS. 4 and 5 can be used for measurements of laser-induced fluorescence performed when the detector is in front of the cuvette. The laser emits pulses of light directed towards an aperture of a first wall. As laser pulses enter the sample, fluorescence is generated which is emitted in all directions (i.e. non-coherent light in all directions, similarly to a lightbulb). The pinhole aperture at the back of the cuvette holder can be used for optical attenuation measurements. The alignment of the cuvette is critical for this type of fluorescence measurement as the incidence angle of the laser beam on the surface of the cuvette and the reflected signal are affected by the angle of the cuvette surface to the laser beam. The cuvette holder 140 can be useful in these high precision measurements. Additionally, external light incident on the cuvette is reduced because only one aperture allows light to enter. Reducing external light can reduce noise within the optical data.

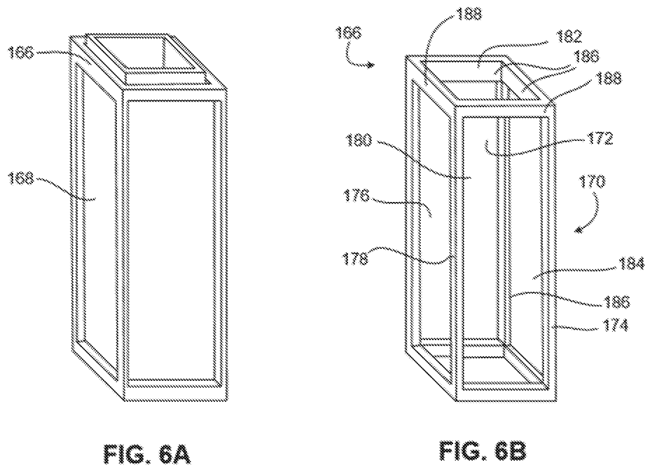

FIGS. 6A and 6B show a cuvette holder 166. In FIG. 6A, the cuvette holder 166 is holding a cuvette 168. The cuvette holder 166 has a body 170 with four walls. Each wall defines an aperture of the cuvette holder. A first aperture 172 extends through a first wall 174, a second aperture 176 extends through a second wall 178, a third aperture 180 extends through a third wall 182, and a fourth aperture 184 extends through a fourth wall 186. The apertures 172, 176, 180, 184 are almost as large as the walls 174, 178, 182, 186 defining the apertures. The first wall 174 and the third wall 182 are opposite each other and the second wall 178 and the fourth wall 186 are opposite to each other. The four apertures 172, 176, 180, 184, have the same dimensions. In some cuvette holders, the apertures have different dimensions. Each wall has an upper crossbar 188. The cuvette holder 166 can include plates that wholly or partially cover the apertures

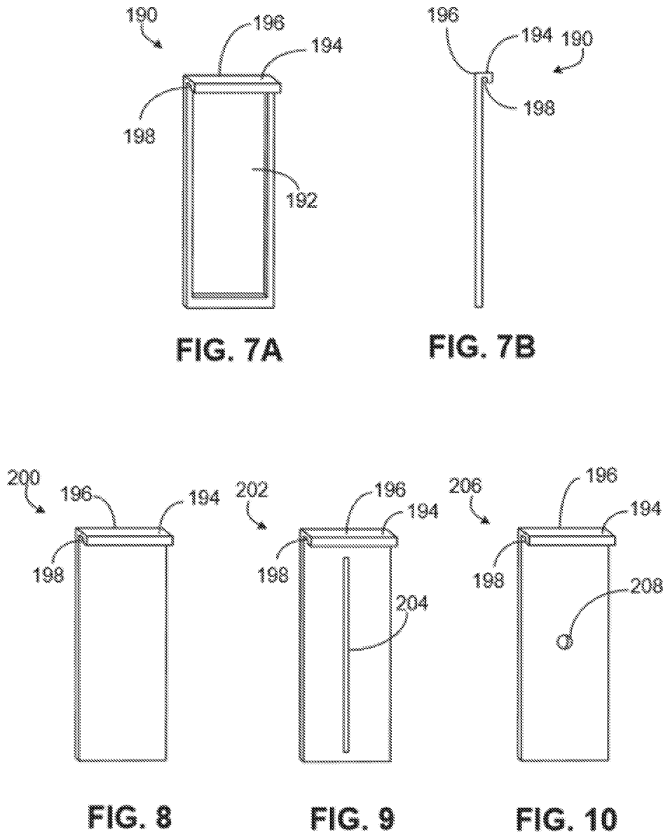

FIGS. 7A-10 show a plurality of plates detachably mountable to an outer surface of the body 170 of the cuvette holder 166. Each of the plates is sized to cover one of apertures.

FIGS. 7A and 7B are a perspective view and a side view of a plate 190 that can be detachably mounted to an outer surface of the cuvette holder 166. The plate 190 has four edges and an aperture 192 that extends through the plate 190. The plate 190 also has a ledge 194 that extends laterally from a first edge 196 of the plate 190. The ledge 194 defines a groove 198 that extends parallel to the first edge 196. The groove 198 is sized to receive the crossbar 188 of a wall of the cuvette holder 166. In use, the plate is mounted on a wall of the cuvette holder 166 with the crossbar 188 in the groove 198 so that the crossbar 188 supports the plate 190. The aperture 192 of the plate 190 allows light to pass through the plate and through the aperture of the wall on which the plate 190 is mounted. The plate 190 can be used to hold an optical filter (not shown). The optical filter may span the entire aperture 192 or may only span a part of the aperture 192. Optical filters that can be attached to the plate 190 include, for example, band pass filters used in fluorescence to isolate specific fluorescence wavelengths that have been excited. The intensity at these wavelengths can be used to characterize the samples in the cuvette. The plate can also be used to house other optical components such as, for example, mirrors, beam splitters, notch filters, and polarizers.

FIG. 8 is a perspective view of a plate 200 that can be detachably mounted to an outer surface of the cuvette holder 166. The plate 200 is free of apertures but is otherwise similar to plate 166, shown in FIG. 7A. The plate 200 is used to block the light emerging from the cuvette and external light entering into the cuvette through the aperture of the wall on which the plate 190 is mounted.

FIG. 9 is a perspective view of a plate 202 that can be detachably mounted to an outer surface of the cuvette holder 166. The plate 202 defines a slit aperture 204 but is otherwise is similar to plate 200, shown in FIG. 8. The slit aperture 204 is a linear opening that extends through the plate 202. Slit apertures 204 can be used in 90-degrees fluorescence measurements and at 90-degree scattering measurements. The slit aperture 204 also attenuates of the light in the forward direction. Attenuation of light in the forward direction limits the forward scattered light on the detector. The plate 202 allows a small amount of light to pass through the aperture of the wall on which the plate 190 is mounted. Slit apertures can be used to measure scattering along a single plane. In some plates, the slit aperture has a length of between 20 mm to 40 mm and a width of 0.5 mm to 1.0 mm. The plate 202 has a slit aperture 204 measuring 30 mm long and 1 mm wide. Plates with a pair of slits positioned in a Young's double slit arrangement can be used to observe the interference patters generated from liquids in cuvettes. In some plates, the slit aperture is horizontal.

FIG. 10 is a perspective view of a plate 206 that can be detachably mounted to an outer surface of the cuvette holder 166. The plate 206 defines a pinhole aperture 208 but is similar to plate 200, shown in FIG. 8. The pinhole aperture 208 has a diameter that controls the amount of light entering the cuvette holder 166. The plate 206 can be used to limit access of light entering the cuvette to a specific size. Limiting light from an external source to a known size is useful when using incandescent light sources. The pinhole 208 is in the center of the plate 206. In some plates, the pinhole is not in the center of the plate.

The plate 206 can be used attenuation measurements, fluorescence measurements, and scattering measurements. In use, an operator places the crossbar 188 in the groove 198 so that the plate 206 hangs on the cuvette holder 166. The plate 206 allows a small amount of light to pass through the cuvette holder 166. Placing the plate 106 on the third wall 182 of the cuvette holder positions the pinhole 208 as an exit pinhole. The exit pinhole 208 can be positioned 180-degrees from an incident light source. An exit pinhole at 180-degrees is useful for attenuation measurements as it limits the amount of forward scattered light on the detector. Limiting the forward scattered light can generate a more accurate measurement of the attenuated light at 180 degrees. This is particularly useful for samples that are highly scattering. The plate 206 can also be placed on the second wall 178. Placing the plate 106 on the second wall 178 of the cuvette holder 166 also positions the pinhole 208 as an exit pinhole 208 that 90 degrees from an incident light source. An exit pinhole at 90-degrees from a light source is useful for both fluorescence and scattering measurements.

The plates 190, 200, 202, 206 can each be mounted on the cuvette holder 166 by receiving the cross bar 188 of the cuvette holder 166 in the groove 198 of the ledge 194. In some cuvette holders, the plates 190, 200, 202, 206 may be detachably mounted using other approaches such as, for example, magnetically attached or attached by snap fasteners.

A number of embodiments of the methods and systems have been described. Nevertheless, it will be understood that various modifications may be made without departing from the spirit and scope of this disclosure. Accordingly, other embodiments are within the scope of the following claims.

What is claimed is:

1. A cuvette holder comprising:
a base;
a body extending from the base, the body comprising a first wall, and the body defining an interior cavity;
wherein a first aperture extends through the first wall of the body, the first aperture having a width measured parallel to the base of between 9.5 and 10.1 millimeters.

2. The cuvette holder of claim 1, wherein a second aperture extends through a second wall of the body, the second aperture having a width measured parallel to the base of between 9.5 and 10.1 millimeters, the second wall of the body adjacent the first wall of the body.

3. The cuvette holder of claim 2, wherein the first aperture and the second aperture are connected and form a single, large aperture spanning the first and the second walls.

4. The cuvette holder of claim 2, wherein a third aperture extends through a third wall of the body, the third wall of the body opposite the first wall of the body and wherein a fourth aperture extends through a fourth wall of the body, the fourth wall of the body opposite the second wall of the body.

5. The cuvette holder of claim 4, wherein the first, second, third, and fourth apertures have the same dimensions.

6. The cuvette holder of claim 5, further comprising a plurality of plates detachably mountable to an outer surface of the body, each of the plates sized to cover one of the first, second, third, and fourth apertures.

7. The cuvette holder of claim 6, wherein one of the plurality of plates is free of apertures.

8. The cuvette holder of claim 6, wherein one of the plurality of plates defines a slit aperture.

9. The cuvette holder of claim 6, wherein one of the plurality of plates defines a pinhole aperture.

10. The cuvette holder of claim 1, wherein the first wall has a thickness between 0.8 and 1.2 millimeters.

11. The cuvette holder of claim 1, wherein the base comprises ferromagnetic material.

12. The cuvette holder of claim 11, wherein the base is at least 10% by weight ferromagnetic material.

13. The cuvette holder of claim 1, wherein the base comprises flanges extending laterally beyond the body, the flanges defining apertures sized to receive fasteners.

14. The cuvette holder of claim 1, wherein the interior cavity has a rectangular cross-section parallel to the base with a length between 12.5 and 12.6 millimeters.

15. The cuvette holder of claim 14, wherein the rectangular cross-section has a width between 12.5 and 12.6 millimeters.

16. The cuvette holder of claim 14, wherein the rectangular cross-section has a width between 3.5 and 3.6 millimeters.

17. The cuvette holder of claim 1, wherein the body comprises a second wall opposite the first wall, the second wall defining a pinhole aperture extending through the second wall.

18. A cuvette holder comprising:
a base; and
a body extending from the base, the body comprising a first wall and a second wall adjacent the first wall, the body defining an interior cavity;
wherein the first wall defines a first aperture extending through the first wall, the first aperture having a width measured parallel to the base of between 9.5 and 10.1 millimeters;
wherein the second wall defines a second aperture extending through second wall, the second aperture having a width measured parallel to the base of between 9.5 and 10.1 millimeters; and
wherein the first aperture and the second aperture are connected and form a single, large aperture spanning the first and the second walls.

19. The cuvette holder of claim 18, wherein the first wall has a thickness between 0.1 and 1.2 millimeters.

20. The cuvette holder of claim 18, wherein the base is at least 10% by weight ferromagnetic material.

21. The cuvette holder of claim 18, wherein the base comprises flanges extending laterally beyond the body, the flanges defining apertures sized to receive fasteners.

22. A cuvette holder comprising:
a base;
four walls extending from the base and defining an interior cavity, each of the four walls defining an aperture extends through the wall, the aperture having a width measured parallel to the base of between 12 and 12.6 millimeters, wherein each of the apertures has the same dimensions; and
a plurality of plates detachably mountable to the body, each of the plates sized to cover one of the apertures.

23. The cuvette holder of claim 22, wherein one of the plurality of plates is free of apertures.

24. The cuvette holder of claim 22, wherein one of the plurality of plates defines a slit aperture.

25. The cuvette holder of claim 22, wherein one of the plurality of plates defines a pinhole aperture.
